(19) United States
(12) Patent Application Publication
(10) Pub. No.: US 2011/0047481 A1
(43) Pub. Date: Feb. 24, 2011

(54) Systems and methods for presenting third party advertisements in a rich media environment

(75) Inventors: Scott G. Morgan, Valencia, CA (US); Joshua Rhoades, West Hills, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., BURBANK, CA (US)

(21) Appl. No.: 12/583,427

(22) Filed: Aug. 19, 2009

(51) Int. Cl. G06F 3/00

(52) U.S. Cl. 715/749; 715/760

(57) ABSTRACT

There is provided a system and method for converting advertisements in a first Internet Application (IA) format for providing a presentation document using a second IA format. There is provided a system comprising a processor configured to obtain and retrieve an advertising script in the first IA format including referenced media assets and an interactive function, translate the interactive function to generate a translated function in the second IA format, generate a wrapper function in the first IA format implementing the interactive function, and provide a container document in the first IA format embedding the wrapper function and the presentation document having the translated function and the referenced media assets, wherein the translated function triggers the wrapper function. In this manner, presentation duties can be handled by a single IA format, avoiding rendering and performance issues resulting from the conventional method of using two IA formats concurrently for presentation.

### BACKGROUND OF THE INVENTION

1. Field of the Invention

The present invention relates generally to Internet marketing. More particularly, the present invention relates to Internet marketing for rich media environments.

2. Background Art

Internet portals, particularly those presented on the World Wide Web (WWW), have assumed an increased importance with today's online and interconnected society. While the limitations of Hypertext Markup Language (HTML) have been sufficient for presenting and organizing textual data, HTML documents cannot easily support rich media capabilities that users have grown to expect from web portals and applications. To bridge that gap, Rich Internet Applications (RIAs) written as plug-ins for web browsers such as Flash, Silverlight, and Java have extended and enriched the multimedia capabilities of modern web browsers beyond the limitations of HTML. In particular, to provide the richest interactivity possible, some online portals are primarily presented using RIAs, with HTML documents only acting as a container for embedding the RIA.

To maintain a high standard for such RIA based Internet portals, sufficient resources need to be dedicated to development. By developing and continually updating a compelling online presence, visitor traffic and brand name recognition can be fostered and matured. This effort generally requires hiring human personnel, providing equipment, and covering other necessary development expenses. However, many users are reluctant to pay subscription fees or provide other direct financial support to enable these development efforts. As a result, sponsorship by third party advertising has emerged as the dominant model for financial sustainability on the Internet. Thus, effective presentation of advertiser messages is of utmost importance for the continued financial viability of many online portals.

While in the past a simple static banner graphic or a simple text message may have been acceptable, today's advertisers demand more flexibility for dynamic and interactive advertising. Advertisers may want to use dynamic window resizing, animation effects, and other advanced presentation capabilities. At the same time, advertisers also strive for the greatest compatibility and ease of integration into existing web infrastructure. To meet these demands, third-party advertising is now increasingly provided using a widely supported scripting language such as Javascript to enable rich interactivity by, for example, manipulating the Document Object Model (DOM) of a corresponding HTML document container. Moreover, such scripting languages can also be utilized to provide client tracking information for marketing analysis and other purposes, which may be of particular importance to advertisers.

Unfortunately, attempting to integrate HTML and scripting based advertisements with a primarily RIA based Internet portal is often difficult, as the two are written in different Internet application formats and cannot be readily integrated in a cohesive manner. While workarounds may exist such as using floating HTML IFrames with transparent or opaque window mode Flash, the resulting web browser incompatibilities, rendering conflicts, reduced performance, unpredictable event timing behavior, increased maintenance complexity, and other issues remain problematic. Developers must spend extra time and resources addressing these issues, while user retention may suffer due to strange browser rendering, slow website loading, and sluggish input responsiveness.

Accordingly, there is a need to overcome the drawbacks and deficiencies in the art by providing a way for third party advertisements to be efficiently and seamlessly integrated into an RIA-based Internet portal.

### SUMMARY OF THE INVENTION

There are provided systems and methods for presenting third party advertisements in a rich media environment, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of a system for presenting third party advertisements in a RIA, according to one embodiment of the present invention;

FIG. 2 presents a diagram of a system for converting advertisements in a first Internet Application (IA) format for providing a presentation document using a second IA format, according to one embodiment of the present invention;

FIG. 3 presents a diagram of displays showing rendered outputs of a web browser from a client accessing a system for presenting third party advertisements in a RIA, according to one embodiment of the present invention; and

FIG. 4 shows a flowchart describing the steps, according to one embodiment of the present invention, by which advertisements in a first IA format may be converted for providing a presentation document using a second IA format.

### DETAILED DESCRIPTION OF THE INVENTION

The present application is directed to systems and methods for presenting third party advertisements in a rich media environment. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

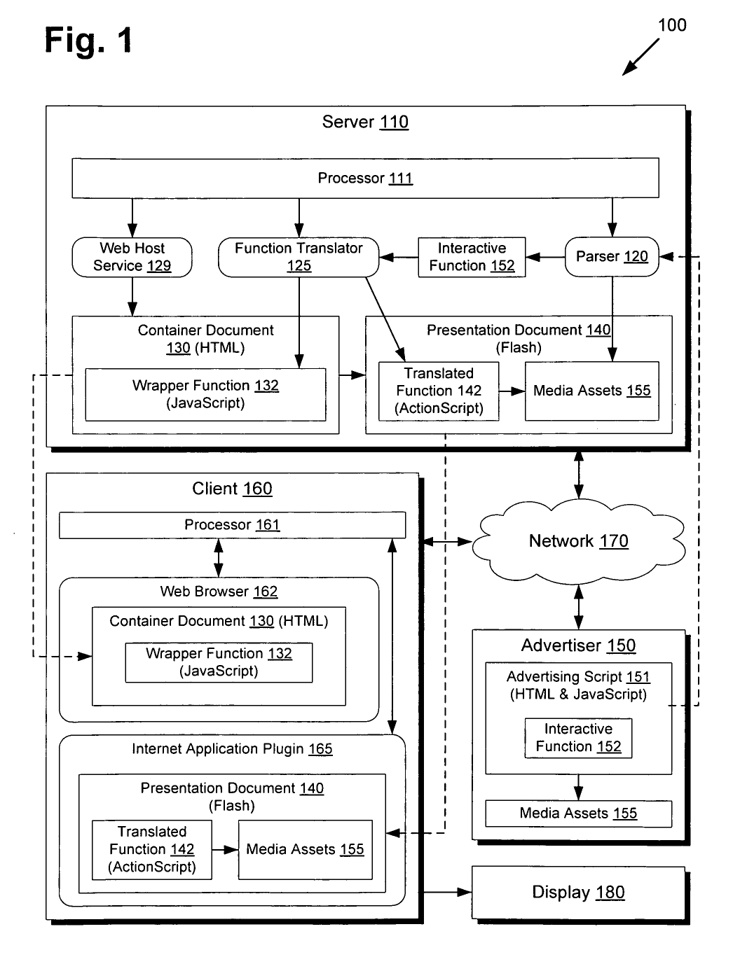

FIG. 1 presents a diagram of a system for presenting third party advertisements in a rich Internet application (RIA), according to one embodiment of the present invention. Diagram 100 of FIG. 1 includes server 110, advertiser 150, client 160, network 170, and display 180. Server 110 includes processor 111, parser 120, function translator 125, web host service 129, container document 130, wrapper function 132, presentation document 140, and interactive function 152. Container document 130 includes wrapper function 132. Presentation document 140 includes translated function 142 and media assets 155. Advertiser 150 includes advertising script 151 and media assets 155. Advertising script 151 includes interactive function 152. Client 160 includes processor 161, web browser 162, and Internet application plugin 165. Web browser 162 includes container document 130. Internet application plugin 165 includes presentation document 140.

FIG. 1 presents an overview of an exemplary exchange between a client, server, and an advertiser over a network for displaying a rich Internet application having integrated advertisements. Server 110 may comprise, for example, a web server for an interactive entertainment portal servicing the general public over network 170, which may comprise a public network such as the Internet. Advertiser 150 may comprise a third party vendor that has an advertising agreement in place with server 110. Client 160 may comprise a desktop computer, laptop computer, mobile phone, or another device having access to network 170 and the ability to execute web browser 162 and Internet application plugin 165 on processor 161. Display 180 may comprise any display, such as a LCD screen, that can display visual data from client 160.

An exemplary exchange for displaying a rich Internet application having integrated advertisements might begin where processor 161 of client 160 executes web browser 162 to access server 110 over network 170. Web host service 129 executing on processor 111 of server 110 may receive a request from client 160 for retrieving a web page, container document 130. Container document 130, shown as a HTML document in FIG. 1, may be structured such that the majority of the content is actually stored within presentation document 140, shown as a Flash application in FIG. 1. As a result, container document 130 may comprise a simple template for embedding the content stored in presentation document 140, which in turn provides rich media presentation capabilities and web interactivity.

Before container document 130 can be sent to client 160 to respond to the original request from web browser 162, it may be desirable to also embed advertising within container document 130. Thus, server 110 may contact advertiser 150 over network 170 to request advertising script 151. As shown in FIG. 1, advertising script 151 may be fed to parser 120 executing on processor 111 of server 110 to separate interactive function 151 and to retrieve any referenced media assets 155 from advertiser 150. While the communications between server 110 and advertiser 150 are in response to the original request from client 160 in FIG. 1, alternative embodiments might use, for example, caching techniques to save a local copy of interactive function 152 and media assets 155 so that redundant requests to advertiser 150 for the same advertisement are not necessary.

As shown in FIG. 1, media assets 155 are inserted into presentation document 140, which may comprise a Flash (.SWF) file. Alternatively, presentation document 140 may externally link to media assets 155. Media assets 155 might include graphical assets such as bitmaps in the Portable Network Graphics (.PNG) format, the Graphics Interchange Format (.GIF), the Joint Photographic Experts Group (.JPG or .JPEG) format, or another image format. Media assets 155 might include audio assets such as audio in a MPEG-1 Audio Layer 3 (.MP3) format. Media assets 155 might also include movie assets such as a video in a MPEG-4 container (.MP4) or even another Flash (.SWF) file.

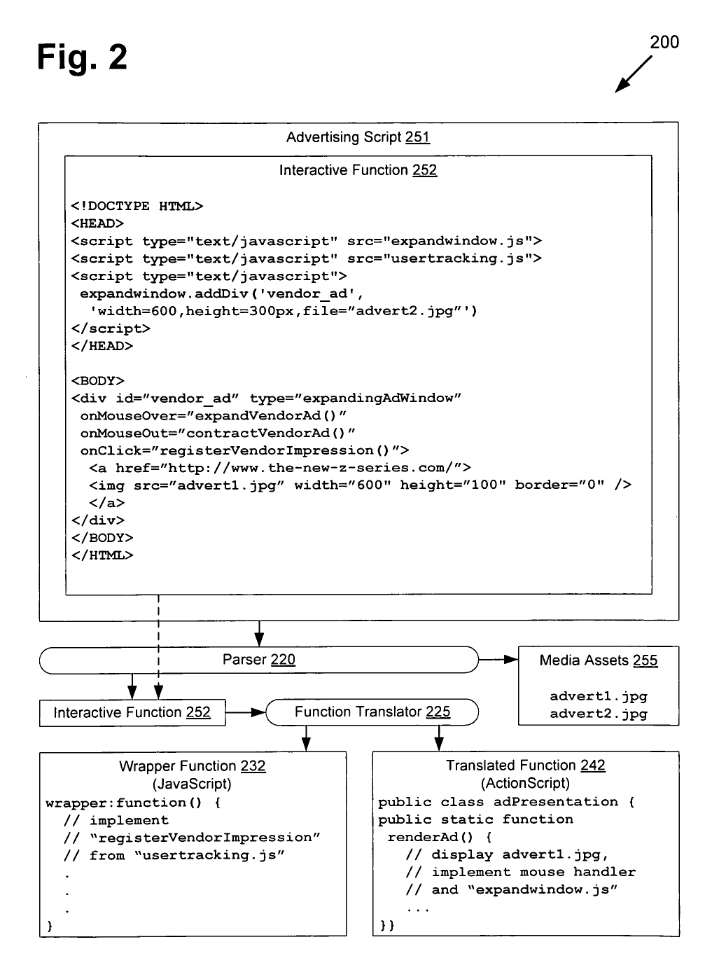

Additionally, parser 120 extracts interactive function 152 from advertising script 151 to feed into function translator 125 executing on processor 111, which splits interactive function 152 into two components, wrapper function 132 and translated function 142. As shown in FIG. 1, wrapper function 132 is embedded within container 130 as JavaScript, whereas translated function 142 is embedded within presentation document 140 as ActionScript. FIG. 2, discussed below, provides a more detailed description of parser 120 and function translator 125.

Having thus prepared container document 130 and presentation document 140, web host service 129 can now provide client 160 with the requested web page. As shown in FIG. 1, web browser 162 processes container document 130, whereas Internet application plugin 165 processes presentation document 140. After discerning that container document 130 references presentation document 140, web browser 162 may initiate the execution of Internet application plugin 165 on processor 161 for retrieving and executing presentation document 140. Web browser 162 and Internet application plugin 165 executing on processor 161 may then render container document 130 and referenced presentation document 140 for viewing on display 180, interactively controllable by an input device connected to client 160, such as a keyboard or mouse, which is omitted from FIG. 1. Web browser 162 may comprise any browser capable of interpreting a HTML document with JavaScript, such as Internet Explorer, Firefox, Opera, Safari, and others. Internet application plugin 165 may comprise, for example, a Flash Player plug-in compatible with web browser 162.

While only a single client, server, and advertiser are shown in FIG. 1 for simplicity, other embodiments may include several clients, servers, and advertisers. For example, several servers may provide redundancy and load balancing, several clients may request web content concurrently, and advertisements may be retrieved from several different advertisers. In particular, to provide a variety of different advertisements to reduce user fatigue and to receive revenue from as many sources as possible, servers may rely on several different advertising vendors and networks by round robin rotation, by random selection, or by another selection basis.

Moreover, although container document 130 is shown to use HTML with wrapper function 132 as JavaScript, advertising script 151 is shown to use HTML and JavaScript, and presentation document 140 is shown to use Flash with translated function 142 as ActionScript, other Internet application languages could also be used as well. For example, Java, Silverlight, and other rich Internet application languages could be substituted for Flash and ActionScript. Although HTML and JavaScript are the most common formats for serving web content, other formats may arise in the future that could substitute for HTML and JavaScript. Thus, more generally speaking, presentation document 140 may be described in one particular Internet application format or language whereas container document 130 and advertising script 151 may be described in another Internet application format or language.

Moving to FIG. 2, FIG. 2 presents a diagram of a system for converting advertisements in a first Internet Application (IA) format for providing a presentation document using a second IA format, according to one embodiment of the present invention. Diagram 200 of FIG. 2 includes parser 220, function translator 225, wrapper function 232, translated function 242, advertising script 251, interactive function 252, and media assets 255. Advertising script 251 includes interactive function 252. With regards to FIG. 2, it should be noted that parser 220 corresponds to parser 120 from FIG. 1, that function translator 225 corresponds to function translator 125, that wrapper function 232 corresponds to wrapper function 132, that translated function 242 corresponds to translated function 142, that advertising script 251 corresponds to advertising script 151, that interactive function 252 corresponds to interactive function 152, and that media assets 255 correspond to media assets 155.

As shown in FIG. 2, interactive function 252 is provided as HTML with inline and referenced JavaScript for controlling presentation, interactivity, and logic of a web advertisement. Although interactive function 252 is referred to in singular, it may actually contain several different functions for supporting the operation of web advertisements. Advertising script 251, which contains interactive function 252, may also contain segments that do not need to be interpreted by function translator 225. These segments might include static code segments that are non-interactive and are executed regardless of user interactions, or alternative segments for browsers that have disabled or limited scripting functionality. Since these segments may be passed through as-is without translating into two functions, it may be more efficient to ignore these segments as non-interactive functions. In FIG. 2, parser 220, which may be executing on processor 111 of server 110 in FIG. 1, is able to separate interactive and non-interactive functions from advertising script 251, so that only interactive function 252 is passed to function translator 225 for further processing.

Parser 220 may use several different techniques for extracting interactive function 252 and media assets 255. The selection of a particular technique may depend on the format of advertising script 251, which in turn may depend on the specific procedures and practices of a selected advertising vendor. For example, some advertisers may mark certain portions with tags or comments to indicate their functionality, or may always provide advertising scripts with functions named or positioned in a well-defined manner. For this type of format, a pattern-based or position-based parser may be more suitable. Other advertisers may provide less rigorously formatted scripts that may need more in-depth analysis. In this case, a more advanced parser that analyses individual statements or traces by using a browser simulator may be necessary. In other cases, it may be more efficient to manually provide an algorithm for parser 220 to interpret particular forms of advertising script 251 on a case-by-case basis. Thus, parser 220 can be configured to adjust algorithms based on a selected advertising vendor or by some other criteria.

As shown in FIG. 2, parser 220 is able to detect two referenced assets from interactive function 252 comprising media assets 255, or “advert1.jpg” and “advert2.jpg.” As previously discussed, besides including bitmap image files, media assets 255 may also include sound, movie, or even Flash (.SWF) files. However, for simplicity, the advertisement used as an example in FIGS. 1-3 only refers to two different static image files of differing sizes, 600×100 pixels and 600×300 pixels. This may be used, for example, to support an advertisement that expands while a mouse cursor hovers over the advertisement. However, as discussed, other types of media assets could be included within media assets 255. For example, a single Flash movie might be provided with the ability to animate between the 600×100 and 600×300 pixel sizes by using ActionScript and/or JavaScript.

After function translator 225 receives interactive function 252 from parser 220, it may produce two different functions, wrapper function 232 and translated function 242, for integration into container document 130 and presentation document 140 of FIG. 1, respectively. As shown in FIG. 2, wrapper function 232 contains the portions of interactive function 252 pertaining to advertising logic, such as user tracking, whereas translated function 242 contains the portions of interactive function 252 pertaining to advertising presentation.

Focusing on wrapper function 232, the function titled “wrapper” implements the “registerVendorImpression” function from the externally embedded “usertracking.js” JavaScript file of interactive function 252. This “registerVendorImpression” function may begin by, for example, reading various tracking data from client 160 of FIG. 1, such as the identity of web browser 162, the screen resolution of display 180, the local time at client 160, the IP address of client 160, cookie data stored by web browser 162, and other information. As shown by the onClick=“registerVendorImpression( )” segment of interactive function 252, “registerVendorImpression” may be invoked when an event listener detects a click through event indicating that the advertisement was clicked. The “registerVendorImpression” function may then track user data as described above, and register an advertisement impression including the user data with advertiser 150 of FIG. 1. The clicked href may then direct web browser 162 to a third party advertiser site “www.the-new-z-series.com” for more detailed information about the advertisement. These operations are given only as an example, and wrapper function 232 might also contain other logical procedures.

Moving to translated function 242, a new class titled “adPresentation” provides a new function titled “renderAd”, which implements in ActionScript the presentation portion of interactive function 252. In other words, the presentation portion of interactive function 252 written in HTML and JavaScript is converted to a native ActionScript representation for a Flash Player plug-in. As shown by the comments in translated function 242, the “renderAd” function should initially display “advert1.jpg” or the contracted advertisement, implement a mouse handler to detect and handle the state of the mouse cursor, and implement corresponding methods contained within “expandwindow.js” for expanding or contracting the advertisement. Thus, the mouse handler of “renderAd” may call the translated ActionScript versions of “expandVendorAd” or “contractVendorAd” as appropriate, or trigger wrapper function 232 and direct the web browser to “www.the-new-z-series.com” if a click through is detected. The specific functions and procedures placed into translated function 242 may depend on the interactivity provided by interactive function 252. Thus, besides resizing an advertisement using media assets 255 as discussed above, translated function 242 could also support, for example, animating, adjusting visibility, and other visual effects.

For function translator 225 to decide which portions to place within wrapper function 232 or translated function 242, factors similar to those discussed above with parser 220 may be considered. To translate HTML and JavaScript provided in interactive function 252 into ActionScript for translated function 242, several different approaches might be considered. As one might recognize, interactive function 252 relies primarily on an external JavaScript file, “expandwindow.js”, to implement the window resizing presentation functionality. If advertising scripts are provided relying on well-defined JavaScript libraries, then a correspondingly translated ActionScript library might be developed, where function translator 225 can recognize the use of those well-defined libraries and select an appropriate translated ActionScript library. If presentation is handled in a more ad-hoc manner with liberal amounts of non-shared in-line scripting, then a more generalized translation interpreter may be necessary, or it may be more efficient to deal with each category of presentation scripts manually on a case-by-case basis.

Although ActionScript may provide mechanisms for directly invoking external JavaScript, such as the ExternalInterface class, this still leaves advertisements to be presented using HTML and JavaScript, which may cause performance and rendering issues when integrating with a Flash web site that prompted the conversion of advertisements into native Flash ActionScript in the first instance. Thus, merely using wrappers or external APIs may be insufficient, which is why the presentation portion of interactive function 252 should be translated into native ActionScript within translated function 242. Once function translator 225 generates wrapper function 232 and translated function 242, the functions may be embedded within container document 130 and presentation document 140 respectively, allowing the presentation portion to operate natively in Flash whereas the underlying advertising tracking and other logic is handled by the original JavaScript. By moving all the presentation duties to Flash ActionScript, the performance and rendering issues from mixing HTML and JavaScript presentation with Flash presentation can be avoided.

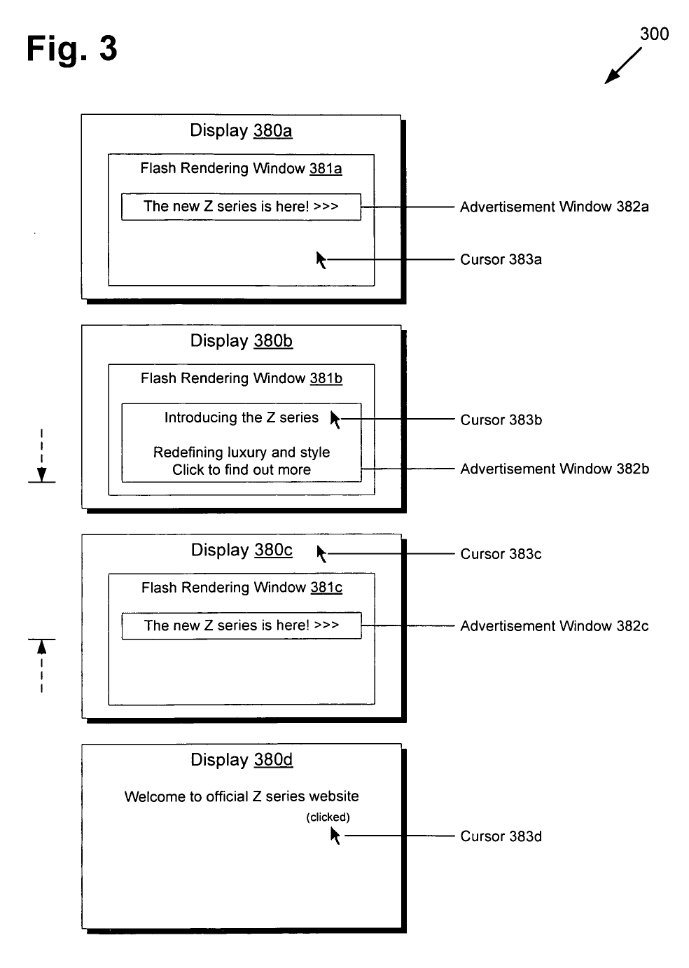

Moving to FIG. 3, FIG. 3 presents a diagram of displays showing rendered outputs of a web browser from a client accessing a system for presenting third party advertisements in a rich Internet application (RIA), according to one embodiment of the present invention. Diagram 300 of FIG. 3 includes displays 380a-380d. Display 380a includes Flash rendering window 381a, advertisement window 382a, and cursor 383a. Display 380b includes Flash rendering window 381b, advertisement window 382b, and cursor 383b. Display 380c includes Flash rendering window 381c, advertisement window 382c, and cursor 383c. Display 380d includes cursor 383d. With regards to FIG. 3, it should be noted that displays 380a-380d correspond to display 180 from FIG. 1.

FIG. 3 shows a simplified diagram of what a user of client 160 in FIG. 1 might view on display 180 as the user interacts with a presented advertisement on a web page. After client 160 of FIG. 1 requests a particular web page from server 110, client 160 may render display 180 similar to display 380a shown in FIG. 1. Flash rendering window 381a may contain the primary content of the web page, which as previously described might comprise an interactive entertainment portal. Advertisement window 382a may then be presented on top of Flash rendering window 381a. The primary content within Flash rendering window 381a may flow around advertisement window 382a or remain hidden under advertisement window 382a. Examining interactive function 252 from FIG. 2, it may be discerned that advertisement window 382a and 382c forms a 600×100 pixel size, whereas advertisement window 382b forms a 600×300 pixel size.

As shown in display 380a, the advertisement shown in advertisement window 382a is initially shown in a contracted form. Since the mouse cursor, cursor 383a, is not hovering over advertisement window 382a, it remains in contracted form until the user moves the cursor within advertisement window 382a. When this happens, the state of display 380a may transition to one similar to display 380b, where cursor 383b is located in advertisement window 382b, which is expanded from advertisement window 382a. Examining FIG. 2, this corresponds to a mouse handler within translated function 242 detecting a “MouseOver” event and executing an ActionScript method implementing the “expandVendorAd” method from “expandwindow.js” of interactive function 252.

Moving to the state shown by display 380b, as long as cursor 383b remains within advertisement window 382b, advertisement window 382b may also remain in the expanded 600×300 pixel size. As with display 380a, main content within rendering window 381b might shift accordingly to make room for the expanded advertisement window 382b, or more portions of rendering window 381b might be obscured by the larger advertisement window 382b. If, however, cursor 383b moves outside advertisement window 382b, then the state of display 380b may transition to one similar to display 380c, where advertisement window 382c contracts back to the same size as advertisement window 382a. Examining FIG. 2, this corresponds to a mouse handler within translated function 242 detecting a “MouseOut” event and executing an ActionScript method implementing the “contractVendorAd” method from “expandwindow.js” of interactive function 252.

On the other hand, if the user decides to click on advertisement window 382b, then the state of display 380b may instead transition to one similar to display 380d, where the user is redirected to the advertiser web site. Examining FIG. 2, this corresponds to a mouse handler within translated function 242 detecting a click through event and triggering the corresponding “wrapper” function in wrapper function 232, which invokes a method similar to “registerVendorImpression” that tracks user data, registers an advertising impression, and additionally redirects the web browser to the advertiser web site.

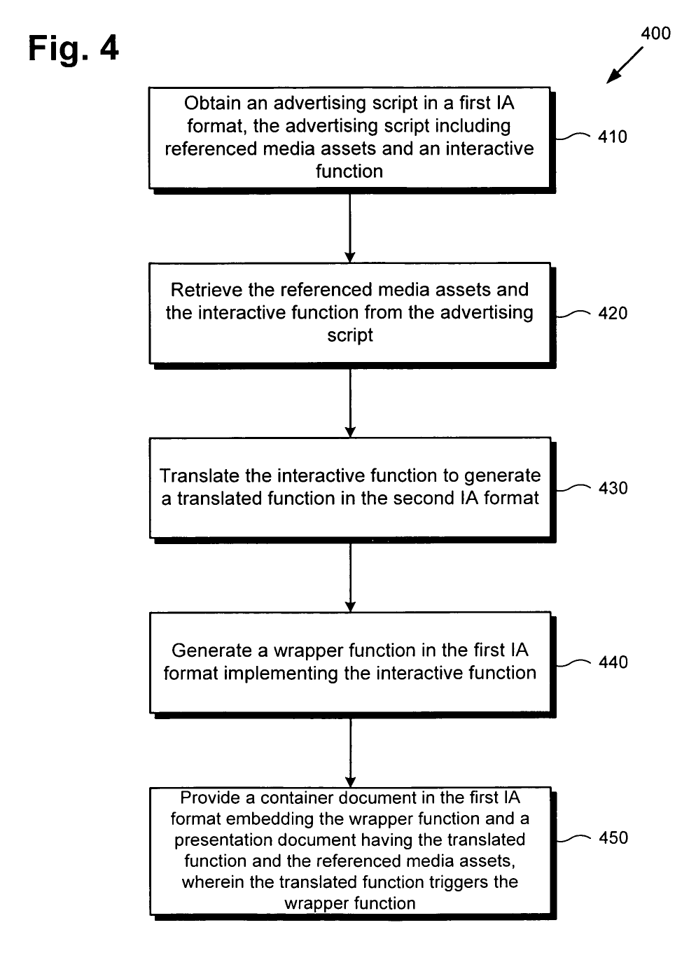

Moving to FIG. 4, FIG. 4 shows a flowchart describing the steps, according to one embodiment of the present invention, by which advertisements in a first Internet Application (IA) format may be converted for providing a presentation document using a second IA format. Certain details and features have been left out of flowchart 400 that are apparent to a person of ordinary skill in the art. For example, a step may comprise one or more substeps or may involve specialized equipment or materials, as known in the art. While steps 410 through 450 indicated in flowchart 400 are sufficient to describe one embodiment of the present invention, other embodiments of the invention may utilize steps different from those shown in flowchart 400.

Referring to step 410 of flowchart 400 in FIG. 5 and diagram 100 of FIG. 1, step 410 of flowchart 400 comprises obtaining advertising script 151 in a HTML and JavaScript format, advertising script 151 including referenced media assets 155 and interactive function 152. As previously described, this may be conducted in advance in combination with a caching algorithm, or on demand when client 160 requests a web page from server 110, which in turn prompts web host service 129 to request an advertising script from advertiser 150. As shown in FIG. 1, communications between devices of FIG. 1 is supported by network 170, which may comprise the Internet as previously described.

Referring to step 420 of flowchart 400 in FIG. 5 and diagram 100 of FIG. 1, step 420 of flowchart 400 comprises retrieving referenced media assets 155 and interactive function 152 from advertising script 151. As previously described, parser 120 executing on processor 111 of server 110 may extract media assets 155 and interactive function 152 from advertising script 151 using various different approaches, which may vary depending on the identity of advertiser 150.

Referring to step 430 of flowchart 400 in FIG. 5 and diagram 100 of FIG. 1, step 430 of flowchart 400 comprises translating interactive function 152 to generate translated function 142 in the Flash ActionScript format. As previously described, function translator 125 executing on processor 111 of server 110 may use various different approaches as with step 420 to translate HTML and JavaScript functions to corresponding ActionScript functions, such as creating an ActionScript library of well-known JavaScript presentation libraries.

Referring to step 440 of flowchart 400 in FIG. 5 and diagram 100 of FIG. 1, step 440 of flowchart 400 comprises generating wrapper function 132 in a HTML and JavaScript format implementing interactive function 152. As previously discussed, wrapper function 132 may specifically implement the logic portions of interactive function 152, such as user tracking or registering advertising impressions.

Referring to step 450 of flowchart 400 in FIG. 5 and diagram 100 of FIG. 1, step 450 of flowchart 400 comprises providing container document 130 in a HTML and JavaScript format embedding wrapper function 132 from step 440 and presentation document 140 having translated function 142 from step 430 and the referenced media assets 155 from step 420, wherein translated function 142 triggers wrapper function 132. As previously described, a click-through event may be detected by translated function 142 for triggering advertising impression logic contained in wrapper function 132 and redirecting web browser 162 to the advertiser web site. Since presentation duties are migrated to Flash ActionScript, issues stemming from mixing HTML and Javascript presentation with Flash presentation layers can be avoided. This in turn provides a more optimized viewing experience for improving user retention, providing benefits that flow to users, Internet marketers, and web developers.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A system for converting advertisements in a first Internet Application (IA) format for providing a presentation document using a second IA format, the system comprising:
a processor configured to:
obtain an advertising script in the first IA format, the advertising script including referenced media assets and an interactive function;
retrieve the referenced media assets and the interactive function from the advertising script;
translate the interactive function to generate a translated function in the second IA format;
generate a wrapper function in the first IA format implementing the interactive function; and
provide a container document in the first IA format embedding the wrapper function and the presentation document having the translated function and the referenced media assets, wherein the translated function triggers the wrapper function.

2. The system of claim 1, wherein the translated function comprises animating an advertisement using the referenced media assets.

3. The system of claim 1, wherein the translated function comprises resizing an advertisement using the referenced media assets.

4. The system of claim 1, wherein the translated function comprises adjusting a visibility of an advertisement using the referenced media assets.

5. The system of claim 1, wherein the wrapper function comprises registering an advertisement impression.

6. The system of claim 1, wherein the translated function triggers the wrapper function by listening for a click through event.

7. The system of claim 1, wherein the first IA format comprises Hypertext Markup Language (HTML) using JavaScript (JS).

8. The system of claim 1, wherein the second IA format comprises a Flash application.

9. The system of claim 1, wherein the second IA format comprises a Silverlight application.

10. The system of claim 1, wherein the second IA format comprises a Java application.

11. The system of claim 1, wherein the processor is further configured to provide the container document to a client comprising a HTML browser rendering the container document to a display.

12. The system of claim 11, wherein the wrapper function comprises gathering data from the client.

13. The system of claim 1, wherein the advertising script is provided by a vendor, and wherein the processor is configured to translate the interactive function using translation algorithms specific to the vendor, and wherein the processor is configured to generate the wrapper function using generation algorithms specific to the vendor.

14. A method for converting advertisements in a first Internet Application (IA) format for providing a presentation document using a second IA format, the method comprising:
obtaining an advertising script in the first IA format, the advertising script including referenced media assets and an interactive function;
retrieving the referenced media assets and the interactive function from the advertising script;
translating the interactive function to generate a translated function in the second IA format;
generating a wrapper function in the first IA format implementing the interactive function; and
providing a container document in the first IA format embedding the wrapper function and the presentation document having the translated function and the referenced media assets, wherein the translated function triggers the wrapper function.

15. The method of claim 14, wherein the translated function comprises animating an advertisement using the referenced media assets.

16. The method of claim 14, wherein the wrapper function comprises registering an advertisement impression.

17. The method of claim 14, wherein the translated function triggers the wrapper function by listening for a click through event.

18. The method of claim 14, wherein the first IA format comprises Hypertext Markup Language (HTML) using JavaScript (JS).

19. The method of claim 14, wherein the second IA format comprises a Flash application.

20. The method of claim 14, wherein the providing of the container document is to a client comprising a HTML browser rendering the container document to a display.
